(19) United States
(12) Patent Application Publication
(10) Pub. No.: US 2023/0177519 A1
(43) Pub. Date: Jun. 8, 2023

(54) TARGETED SELECTION AND PRESENTATION OF ALERTS

(71) Applicant: Avaya Management L.P., Durham, NC (US)

(72) Inventors: Prasant Jena, Pune (IN); Shamik Shah, Pune (IN); Amit Pansuria, Pune (IN); John Young, Buntingford (GB)

(21) Appl. No.: 17/545,087

(22) Filed: Dec. 8, 2021

(51) Int. Cl. G06Q 30/00; G06F 40/30; G06F 40/42

(52) U.S. Cl. CPC G06Q 30/016; G06F 40/30; G06F 40/42

(57) ABSTRACT

When an agent is about to be connected to a customer for a communication, there is a small window of time in which the agent may be presented with information determined to be relevant to the communication. After the window closes, the communication may then be connected to the customer. If too much information is presented, the agent may be unable to ascertain or retain such information. However, a neural network to determine the most relevant customer attributes and selecting cues corresponding to the most relevant customer attributes for presentation on an agent device, allowed the agent to be presented with only the most relevant information in a retainable manner.

### FIELD OF THE DISCLOSURE

The invention relates generally to systems and methods for training a neural network and particularly to training the neural network to recognize attribute relevancy associated with a communication.

### BACKGROUND

On busy days, agents in a contact center work on several calls with several customers. To serve customers better, either by providing better solutions or offering good proposals, the agents need to be prepared for the call prior to being connected to the customer. While preparedness may come by visually scanning the customer information available on the screen, this can be time consuming. For visually impaired agents, handicapped agents, or aged agents, quickly focusing on and scanning customer information, which may comprise a substantial volume of information, is a difficult task. There is an even bigger challenge of passing on the customer information, insights and any call related assistance to other agents who subsequently take the call or portion of the call with the same customer. Being able to assess the call and/or customer quickly and accurately, impacts the number and the quality of the interactions handled by the agents.

### SUMMARY

Existing solutions provide on-screen customer data. Reading text on a screen is time consuming and also requires agents to focus on the screen which is difficult for differently abled agents as well as agents-on-the-move. Reading through a customer’s background, especially when agents are expected to answer the call quickly, can cause many agents to merely scan the information without understanding any relevant information for the current call. As a result, calls often take longer than expected as agents need to gather relevant information, such as directly from the customer or while attempting to engage with the customer, when pre-call scanning of textual information failed to be obtained or retained. For example, a listing of textual information may have been presented to the agent prior to connecting to the customer, but the agent may have focused on old, irrelevant, or inaccurate information. When an agent attempts to quicky gather as much information as possible, they may scan the information too quickly and fail to identify or retain the information relevant to the current call.

These and other needs are addressed by the various embodiments and configurations of the present invention. The present invention can provide a number of advantages depending on the particular configuration. These and other advantages will be apparent from the disclosure of the invention(s) contained herein.

Embodiments herein leverage and extend, in part, the system resources that are commonly utilized in contact centers. Contact centers often have a wealth of information on particular customers, issues, work items. etc. However, presenting all available information to an agent would result in “information overload” and require an excessive amount of time to read and assimilate, which is in direct conflict with the key objective of quickly connecting the customer with an agent. Therefore, targeted information is determined and presented prior to connecting the agent to the customer and/or during a call.

In an extreme case, an agent could be given hours, perhaps more, of uninterrupted time to exhaustively read all notes regarding a customer and/or an issue associated with a previous interaction with the customer. However, while the agent is reading the background, the customer is waiting on hold. Not only does this adversely affect the system and networking operations, as connection resources are being tied-up to maintain the customer’s connection while on hold, but the customer’s sentiment is likely to degrade quickly. As a result, the opportunity to obtain a favorable outcome from the call will similarly degrade and necessitate the need for additional calls or other actions, such as when the customer abandoned the call there would be a subsequent need to utilize resources for re-establishing, re-routing, and again bringing an agent up to speed in order to address the customer’s needs. Resources may be very limited in some contact centers, or substantial in other contact centers, however, no contact center has unlimited resources. A call being maintained may require resources that cannot be utilized for other calls.

In one embodiment, alerts are provided as sounds, such as generated speech or other sounds known to convey a particular meaning. The sounds may be presented prior to connecting with the customer or on a “whisper channel” presented to the agent but not the customer after connecting. In other embodiments, the information may be presented visually, tactilely (e.g., via a Braille output device), or in other forms or a combination thereof as determined by an agent’s abilities and/or preferences.

Before the agent is connected with the customer to engage in a real-time communication (e.g., voice, voice with video), the amount of time the customer is on hold waiting for the connection can be a critical factor. Not only does the amount of time a customer is on hold affect the customer’s sentiment and risk unnecessary taxing of the network and computing resources, but for contact centers dealing with emergency issues (e.g., poison control, reporting gas leaks, downed power lines, emergency services, etc.), delays may exacerbate the reason for the call and may pose additional risks to people and property.

Accordingly, and in one embodiment, customizable in-ear prompts are provided which may be selected and/or formatted to be presented in a time equal to the length of the ring (e.g., less than three seconds, three to five seconds, less than ten seconds, and no more than a previously determined maximum ring time) presented on the customer’s communication device prior to being connected. As a result, the customer hears a set number of rings, during which time the agent is being presented with relevant information regarding the customer and/or reason for the call, and the agent and customer are then connected and the real-time communication commences.

The information presented to the agent may be obtained from one or more sources including, but not limited to, one or more of: customer journey information (date(s) of prior interactions, channels/modes of the interactions, outcome/sentiment (average and/or most recent); call context, reason for the call; customer’s past experience, “temperature” level based on past interactions (e.g. good/bad experience with respect to same, related or a different product); type/personality of the customer as analyzed by customer’s profile, socio-economic background, etc.; demographic details (e.g. origin and current location of the customer); customer’s interests, likes, and other related information gathered from history, background and type of the customer; recent activities, purchases and other information as captured from social media; and the agent’s own proficiency levels and skills. Any one or more of the foregoing are captured by prior interactions with the contact center and/or any other data source (e.g., social media).

In another embodiment, an Artificial Intelligence (AI), such as a neural network or other machine learning component, accesses the source information to create a relevant summary to be presented to the agent. The summary may be determined by the AI to be one or more of most relevant facts or cue associated with facts (e.g., sound having a known symbolic representation). As a benefit, the agent may better engage with the customer to conclude the communication more expeditiously and successfully as well as promote the customer’s satisfaction with the interaction and related enterprise.

In another embodiment, an in-call suggestion or cue, such as a hint, suggestion, or more details, can be determined by the AI and provided to the agent. In-call cues may be automatically triggered and presented, or triggered from an agent’s request. Factors acquired for in-call cues may include, but are not limited to, one or more of: the on-going call conversation (e.g., words, phrases, emotional content, subject matter, etc.); real-time conversation analysis using speech-to-text/text-to-speech (STT/TTS); a history of similar conversation, context with same or similar type/personality of customer, etc.; and any new/existing agent assist capabilities or data-sources.

For in-call suggestions or cues, any one or more of the foregoing factors may be considered alone or in conjunction with the pre-call factors (see above). As a result, accurate assessment and relevant information can be derived and provided to the agents in-ear (or via other means) comprising relevant hints and suggestions to drive the conversation in a meaningful and fruitful direction. This will enhance the customer experience as well as enable the agents to handle any real-time situation with a higher level of proficiency. This also enables the agents to explore any up-sell opportunities with the customer if it arises during the call, especially when agents are either differently abled, or while handling the call on-the-move.

Providing the cue, suggestion, or other content can be in the form of voice prompt (e.g., generated or recorded speech). Additionally or alternatively, non-speech aural content may be utilized. For example, a customized tone, beep, or other sound that is sufficient for the agent to understand a corresponding and pre-determined meaning (e.g. a long beep would mean that the agent is about to be connected to a crucial call, a soothing sound may mean a simple customer query is anticipated, series of beeps during the call to indicate on-going/arriving of sensitive/crucial information during the call, etc.). The non-speech aural content may be a modification of, or otherwise serve as, a “ring” notification to the agent.

In another embodiment, a second cue or suggestion may be provided to the customer prior to being connected. The information gathered may be similar to the information gathered for the agent, but may additionally or alternatively include: the name and/or type of agent they’re going to be talking to; skill(s) of the agent; and limitations (e.g., bandwidth limitations, system or component operational/non-operational status, agent handicap, etc.).

In another embodiment, the data mining takes the length of information (i.e., time to convey) or time available as an input and, therefrom, creates the cue or suggestion to fit within the available timeframe. Not only does such consciousness improve the customer experience by connecting the call without undue delay, but also complies with certain regulatory requirements (e.g. OFCOM, the UK’s communication regulator, requires agents to be connected to the customer within 2 seconds). Whereas in regions where there are no such regulations, the hints/suggestions may be more verbose or detailed.

AI’s, such as neural networks, are trained. The training may be on an initial dataset(s) prior to use, but may also include feedback for use in subsequent training sets. Accordingly, and in another embodiment, the agent provides feedback to the AI. The feedback may indicate if the cue or suggestion was appropriate, effective, useful, distracting, etc. The AI may then take this information for use in a subsequent training set so as to further reinforce the decisions that lead to beneficial suggestions and/or down weight or discard the decisions that do not lead to beneficial suggestions. The feedback can be binary (e.g., answer yes or no as to whether the cue or suggestion was beneficial) or more elaborate, such as textual information or vocal information, and can be mined using either of STT or TTS and extract positives (for subsequent reinforcement) and negatives (for subsequent down weighting/discarding).

In another embodiment, the proposed idea increases/decreases the in-ear ring length for the agent and/or the customer upon determining the criticality of the summarized information.

The proposed idea thus helps differently abled agents, aged agents, and on-the-move agents by having a quick summary of the call they’re going to attend and/or having hints/suggestions and opportunities provided to them during the call using the available system resources (e.g., the in-ear ringing).

In another embodiment, a system is disclosed, comprising: at least one processor having instructions maintained in a non-transitory memory that cause the at least one processor to perform: selecting a subset of customer attributes selected from a set of known customer attributes, as the most relevant customer attributes for a communication comprising a customer and an agent and wherein the subset of customer attributes is further limited to only customer attributes that are able to be encoded as a cue to cause the cue to have a presentation duration that does not exceed the duration of a ring signal when presented on an agent device to announce the communication; signaling the agent device to present the cue to announce the communication and omitting the ring signal; upon determining the cue has been presented by the agent device, establishing the communication comprising connecting the agent device to the customer device via a communication network.

In another embodiment, a system is disclosed, comprising: at least one processor having instructions maintained in a non-transitory memory that cause the at least one processor to perform: accessing a comprehension rate for the agent; selecting a subset of customer attributes selected from a set of known customer attributes, as the most relevant customer attributes for a communication comprising a customer and an agent and wherein the subset of customer attributes is further limited to only customer attributes that are able to be encoded as a cue to cause the cue to have a presentation duration that does not exceed a volume of information determined to be presented within the presentation duration and presented at a rate not exceeding the comprehension rate for the agent; and during the communication, signaling an agent device to present the cue.

In another embodiment, a system is disclosed, comprising: at least one processor having instructions maintained in a non-transitory memory that cause the at least one processor to perform: selecting a subset of agent communication attributes selected from a set of known agent communication attributes, as the most relevant agent communication for a communication comprising a customer and an agent and wherein the subset of agent communication is further limited to only agent communication attributes that are able to be encoded as a cue to cause the cue to have a presentation duration that does not exceed the duration of a ring signal when presented on a customer device to announce the communication; signaling the customer device to present the cue to announce the communication and omitting the ring signal; upon determining the cue has been presented by the customer device, establishing the communication comprising connecting the agent device to the customer device via a communication network.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, microcode, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a third system in accordance with embodiments of the present disclosure;

FIG. 4 depicts a first data structure in accordance with embodiments of the present disclosure;

FIG. 5 depicts a second data structure in accordance with embodiments of the present disclosure;

FIG. 6 depicts a first process in accordance with embodiments of the present disclosure;

FIG. 7 depicts a feedback interface in accordance with embodiments of the present disclosure; and

FIG. 8 depicts a fourth system in accordance with embodiments of the present disclosure;

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference to one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

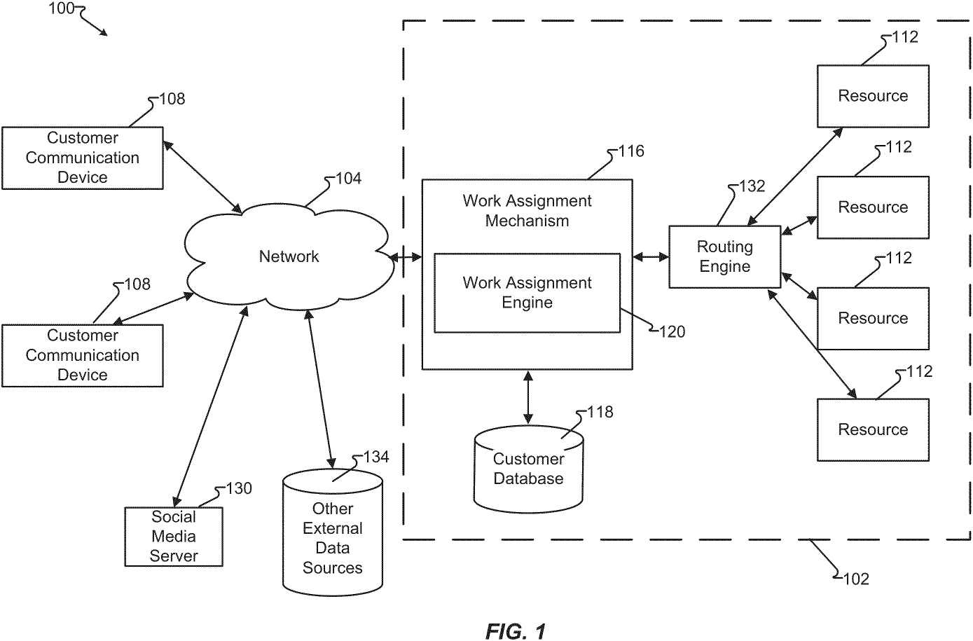

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Pat. Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The customer communication devices 108 may correspond to customer communication devices. In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. Pat. Application Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the customer communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or collection of communication equipment. Examples of a suitable customer communication device 108 include, but are not limited to, a personal computer, laptop, Personal Digital Assistant (PDA), cellular phone, smart phone, telephone, or combinations thereof. In general, each customer communication device 108 may be adapted to support vide o, audio, text, and/or data communications with other customer communication devices 108 as well as the processing resources 112. However, the embodiments herein, the communications are limited to real-time communications, such as voice and voice with video. However, it should be appreciated that non-real time communications (e.g., email, turn-based text chats, etc.) may also benefit from embodiments disclosed herein, such as to promote productivity and accuracy of such non-real time communications. The type of medium used by the customer communication device 108 to communicate with other customer communication devices 108 or processing resources 112 may depend upon the communication applications available on the customer communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. Pat. Application Serial No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed amongst a plurality of service provider customers, one being contact center 102.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

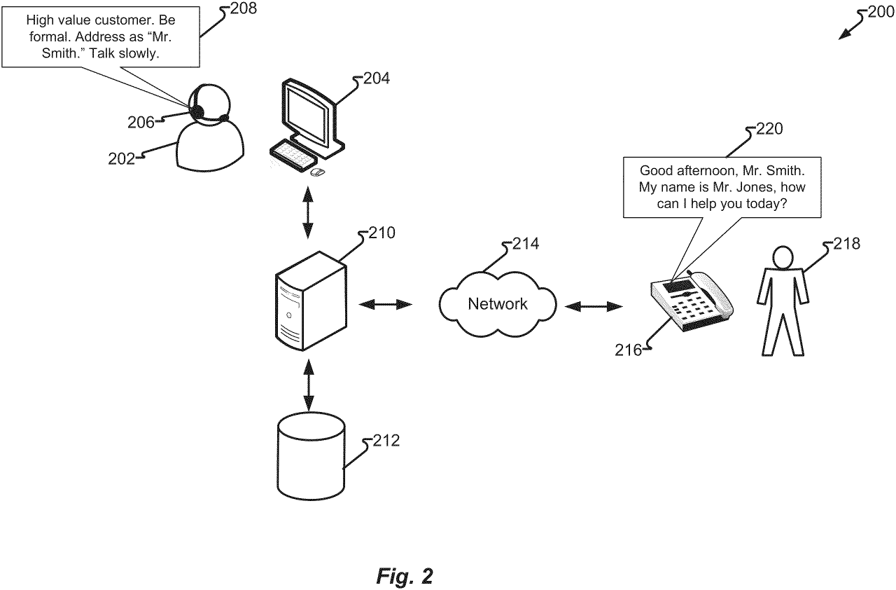

FIG. 2 depicts system 200 in accordance with embodiments of the present disclosure. In one embodiment, system 200 illustrates portions of contact center 102 and omits other portions to avoid unnecessarily complicating the figure and related description. Resource 112 is embodied as a live agent, such as agent 202 agent, utilizing device 204 and optionally headset 206 to engage in real-time communications via network 214 with customer communication device 108, such as customer device 216, when similarly embodied for real-time communications.

In one embodiment, such as for inbound calls (e.g., communication utilizing sound to convey speech and/or video), the call originates by customer 218 placing the call with customer device 216. The call may initially be received from network 214 by one or more of a number of components (see, FIG. 1) but herein is illustrated as server 210, but which may be, comprise, or be comprised by one or more of work assignment mechanism 116, work assignment engine 120, routing engine 132, etc. One a routing decision is made and a target agent selected, the call is announced. The prior art announces a call, such as by triggering a ring event on agent device 204, which may further be presented as a flashing light, text message, symbolic message (e.g., icon or graphic), or audio message, such as presented on a speaker (not shown) or headset 206. Agent 202 may be automatically connected with the customer 218 or provide an input signal to accept the call and, in response to doing so, agent 202 is connected to customer 218. In other embodiments, the input signal is provided automatically, such as after the passage of a previously selected duration of time (e.g., two seconds). In one embodiment, the call announcement is modified to provide a cue to agent 202 of the most relevant information for agent 202 to have for the call with customer 218 prior to being connected as a node on the call topology.

Similar to the forgoing description of inbound calls, and in another embodiment, for outbound calls, a component of contact center 102 may dial the endpoint (e.g., customer device 216) and upon receiving an answer signal therefrom, select an agent to connect the agent to the call. After which agent 202 via agent device 204 has a small window of time (e.g., two seconds) to be connected to the call and initiate the content (e.g., talking) of the communication.

In another embodiment, the cues may be provided mid-call. For example, server 210 may determine that an attribute of customer 218, which may include a motivation or other reason or attribute of the communication, and present a cue associated with the attribute to agent 202, such speech or other sound provided in a “whisper” channel. Additionally or alternatively, text (e.g., pop up message presented on a display of agent device 204) may provide the cue. Time is critical and limited. Accordingly, the cue is selected to only include information that is both the most relevant attribute of customer 218 for the known or predicted content of the communication. Additionally, the cue is limited to a predetermined time. For example, the cue may replace the “ring” announcement on agent device 204 and be of similar or the same length (e.g., two seconds). In another embodiment, a record of attributes for agent 202 may be maintained in database 212 and/or other data repository. The record may include a rate of comprehension (e.g., maximum number of words read and understood per a unit of time, fastest rate of speech presented and understood, etc.). Accordingly, the volume of information (e.g., text, symbols, etc.) in the cue is limited that determined to be comprehended for the previously determined duration of the cue.

When the cue is embodied as a text message, the content presentation area may be size limited. Accordingly, in another embodiment, the cue may be selected to comprise a volume of text (i.e., number of characters) that may be presented in a particular window, such as without altering a previous set font size and/or format (e.g., kerning, italics, etc.) that would allow non-fixed width fonts to present more information within a given space and without altering the content of the fixed space available to present the cue or the content of the cue presented at any one time, such as by such as by paging, scrolling, etc.

In another embodiment, server 210 determines the most relevant attribute(s) of customer 218. Attributes of customer 218 are nearly infinite. For example, customer 218 utilizing customer device 216 to initiate a call to contact center 102 and agent 202 may provide caller-ID information, such a name registered to customer device 216, which is often the same as the name of customer 218 and/or telephone number or other endpoint address. While such information may be useful, it may not be determined to be the most useful attribute(s). For example, if contact center 102 is a poison control number, getting to the details of the incident (e.g., description of the poison, symptoms of poisoning shown by the victim, etc.) may be the most relevant attributes of the call and, therefore, of customer 218, even if the telephone number is also an attribute. Accordingly, an artificial intelligence (AI), such as a neural network, may be trained and provided with attributes of customer 218 to determine the most relevant attributes for the communication that is, or soon will be, underway.

In another embodiment, database 212 may comprise records such as sound files or sound generation instructions. When server 210 determines a most relevant attribute, a processor of server 210 may then construct or playback an associated sound file corresponding to the most relevant attribute.

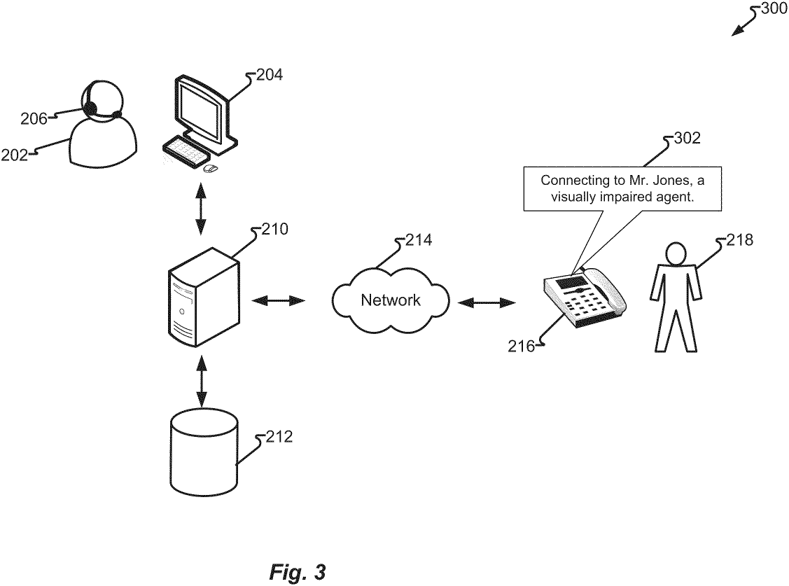

FIG. 3 depicts system 300 in accordance with embodiments of the present disclosure. In one embodiment, system 300 illustrates portions of contact center 102 and omits other portions to avoid unnecessarily complicating the figure and related description. Resource 112 is embodied as a live agent, such as agent 202 agent, utilizing device 204 and optionally headset 206 to engage in real-time communications via network 214 with customer communication device 108, such as customer device 216, when similarly embodied for real-time communications.

System 300 illustrates the presentation of cue 302 to customer 218 on customer device 216. For example, cue 302 may announce an attribute of agent 202 and/or a system (e.g., “You will now be connected to agent Jones. Please be aware that questions about your account may be unanswerable due to a current system outage.”). In another embodiment, cue 302 may describe an attribute of agent 202 that may affect the communication with customer 218.

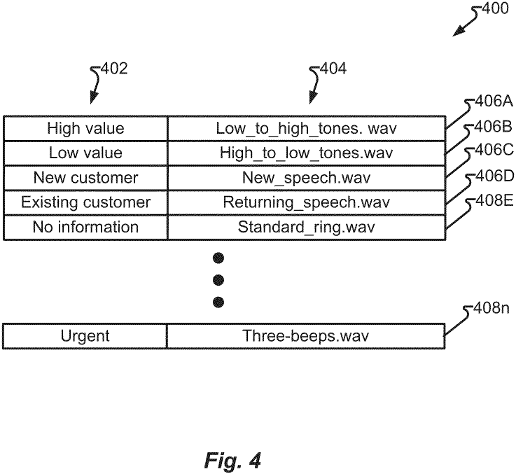

FIG. 4 depicts data structure 400 in accordance with embodiments of the present disclosure. In one embodiment, data structure 400 is maintained in a data storage, such as database 212 and/or other device(s). Data structure 400 comprises a number of records 406 each having a first field 402, comprising customer attributes, and second field 404 comprising an associated audio file.

When a processor, such as a processor of server 210, determines that a most relevant customer attribute matches an entry in first field 402, the corresponding audio file from second field 404 is selected. For example, if the most relevant customer attribute for a particular customer is that they are a new customer, then a match may be found in first field 402 for record 406C and the corresponding sound file (e.g., “New_speech.wav”) selected from second field 404, such as to generate or playback recorded speech welcoming a new customer. Additionally or alternatively, a text record or file may be utilized in place of a sound file wherein the contents of the text processed via text-to-speech and the resulting speech presented to agent 202 via device 204. Text may be concatenated with other text, before text-to-speech conversion, and/or concatenate with other sound files to present a single sound comprising multiple components.

Data structure 400 and records 406 may also comprise other attributes of the field, such as the length of time required to present the generated or playback of the sound file, in order to more readily determine a number of sound files to string together as the available time allows. For example, if a prioritized set of customer attributes identifies the most relevant customer attributes as being “high value” and “new customer” in first field 402, then the associated sound files identified in second field 404 are selected and presented in sequence, as time allows (e.g., duration of the ring signal).

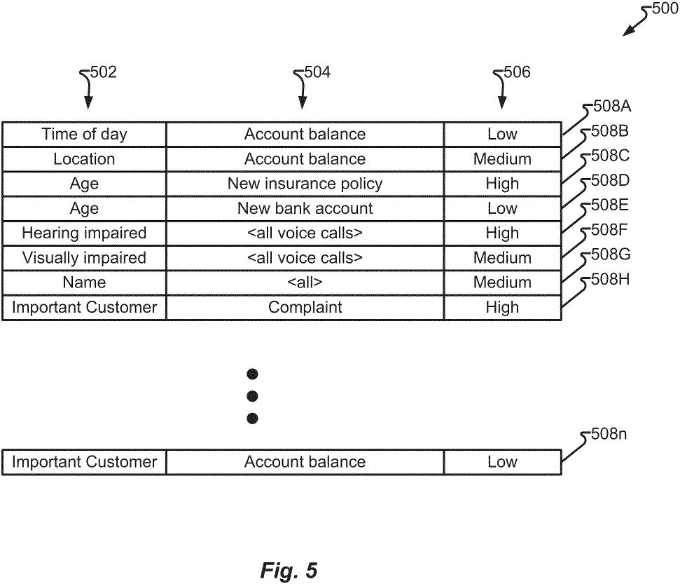

FIG. 5 depicts data structure 500 in accordance with embodiments of the present disclosure. In one embodiment, data structure 500 is maintained in a data storage, such as database 212 and/or other device(s). Data structure 500 comprises a number of records 508 each comprising first field 502 comprising a number of customer attributes, second field 504 identifying subject matter for a communication with the customer, and third field 506 identifying a priority.

Accordingly, a processor, such as a processor of server 210 may access data structure 500 and determine an attribute for a particular customer 218. The attribute may be prioritized, such as via a corresponding value from third field 506. However, whether or not a particular attribute is the, or one of, the most relevant customer attributes for a communication may depend, in whole or in part, on the type of communication. For example, a communication with a particular customer 218 may be determined or known to have a subject matter matching an entry in second field 504. As a result, the particular customer attribute, for a particular subject matter, may have a corresponding priority identified in a corresponding record 508 in third field 506.

In one embodiment, data structure 500 may be utilized to determine whether an identified customer attribute for a particular customer 218, and for a particular subject matter of a communication comprising agent 204, is a particular priority. A priority may be ranked numerically, weighted, or otherwise indexed to determine one attribute as a most relevant customer attribute for a customer 218 and communication subject matter. Additionally or alternatively, if time permits to present a plurality of sound files, the priority may be utilized to determine two or more most relevant customer attributes to be presented, via the corresponding sound files, within the previously determined time frame (e.g., within the duration of a ring signal). In another embodiment, data structure 500 may be utilized to perform, at least a portion, of a training on AI system, such as a neural network. After which the AI may learn by observing communications with a number of customers and the success, or lack thereof, of an outcome of the communication (e.g., issue was resolve, transaction completed, etc.) and/or attribute of the resulting communication (e.g., customer was satisfied, angry, happy, etc.).

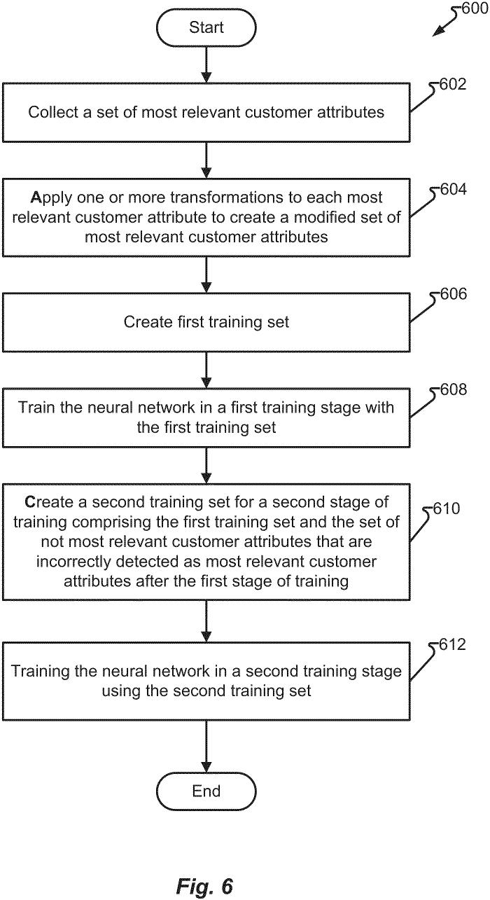

FIG. 6 depicts process 600 in accordance with embodiments of the present disclosure. In one embodiment, process 600 comprises machine-readable instructions that when read by a processor, such as a processor of server 210 or other computing device, causes the process to perform the steps of process 600. Process 600 is directed to the training a of a neural network.

A neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive.

Process 600 begins and, in step 602, collects a set of most relevant customer attributes, such as from a data storage (e.g., database 212, customer database 118, etc.). Additionally or alternatively, the most relevant customer attributes may be collected from a data storage that further identifies a corresponding topic or subject of a communication to further indicate most relevant customer attributes for the subject matter discussed in the communication. Step 604 then performs one or more transformations to each of the most relevant customer attributes. The transformations including, but not limited to, one or more of deletion of one or more customer attributes, adding an omitted customer attribute, emphasizing one but less than all most relevant customer attributes, deemphasizing at least one but less than all most relevant customer attributes. A modified set of most relevant customer attributes is then created from the most relevant customer attributes as transformed. Step 606 then creates a first training set from the set of most relevant customer attributes and the modified set of customer attributes. The neural network is trained with the first training set in a first training stage in step 608.

Step 610 creates a second training set for a second stage of training comprising the first training set and the set of not most relevant customer attributes that are incorrectly detected as most relevant customer attributes after the first stage of training. Step 612 trains the neural network in the second training state using the second training set. Once trained, the neural network may be presented with a set of customer attributes, and optionally subject matter of desired communication with an agent. The neural network then determines a most relevant customer attribute, which may then be presented as an audio cue or other representation to the agent prior to connecting to the customer and initiating the communication.

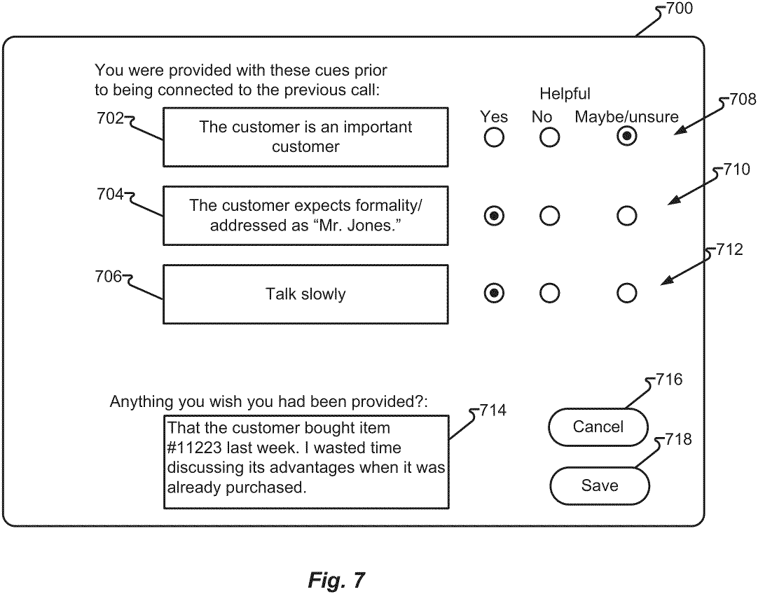

FIG. 7 depicts feedback interface 700 in accordance with embodiments of the present disclosure. In one embodiment, interface 700 comprises representations of an output of a processor, such as a processor executing machine-readable instructions, as presented on energized portions of a display, such as a display of agent device 204. In one embodiment, during or following a communication with a customer, the agent engaged in the communication is presented with feedback interface 700 to receive inputs, such as via an input-output device (e.g., mouse, keyboard, touchscreen, touchpad, etc.).

In one embodiment, feedback interface 700 presents one or more representations, such as representations 702, 704, 706, of a cue or portions of a cue presented to the agent prior to the start of the communication. Graphical elements 708, 710, 712 then receive an input, such as to indicate whether such information was useful in the particular communication. Additionally or alternatively, the agent may have desired to have some particular information, that is, an absent most relevant information, that was not presented. Accordingly, input 714 then receives absent information. Feedback from input 714, and/or graphical elements 708, 710, 712 are then provided to a neural network or other process. As a result, customer attributes determined to be most relevant customer attributes that are provided in or prior to a communication, that were found useful, will reinforce such attributes as most relevant customer attributes when in the same or similar attributes in future communications. Conversely, attributes determined to be most important attributes but were found by the agent to be not, or less useful, will be down weighted or otherwise discounted and less likely to be determined as most relevant customer attributes in future communications. Similarly, absent customer attributes that were deemed beneficial had they been presented, will be more likely to be presented in future communications.

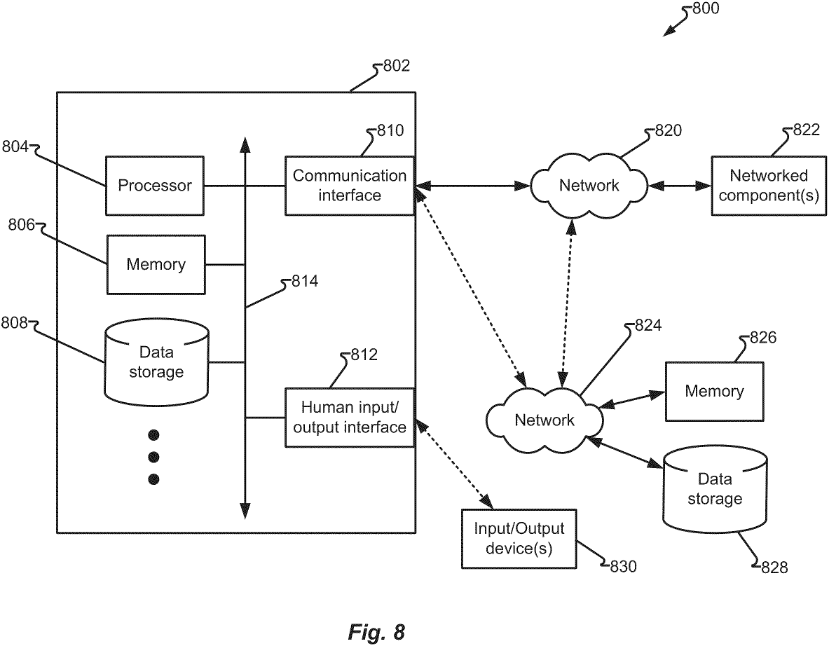

FIG. 8 depicts device 802 in system 800 in accordance with embodiments of the present disclosure. In one embodiment, agent device 204 and/or server 210 may be embodied, in whole or in part, as device 802 comprising various components and connections to other components and/or systems. The components are variously embodied and may comprise processor 804. The term “processor,” as used herein, refers exclusively to electronic hardware components comprising electrical circuitry with connections (e.g., pin-outs) to convey encoded electrical signals to and from the electrical circuitry. Processor 804 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 814, executes instructions, and outputs data, again such as via bus 814. In other embodiments, processor 804 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 804 is a non-transitory computing device (e.g., electronic machine comprising circuitry and connections to communicate with other components and devices). Processor 804 may operate a virtual processor, such as to process machine instructions not native to the processor (e.g., translate the VAX operating system and VAX machine instruction code set into Intel® 9xx chipset code to enable VAX-specific applications to execute on a virtual VAX processor), however, as those of ordinary skill understand, such virtual processors are applications executed by hardware, more specifically, the underlying electrical circuitry and other hardware of the processor (e.g., processor 804). Processor 804 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 804, device 802 may utilize memory 806 and/or data storage 808 for the storage of accessible data, such as instructions, values, etc. Communication interface 810 facilitates communication with components, such as processor 804 via bus 814 with components not accessible via bus 814. Communication interface 810 may be embodied as a network port, card, cable, or other configured hardware device. Additionally or alternatively, human input/output interface 812 connects to one or more interface components to receive and/or present information (e.g., instructions, data, values, etc.) to and/or from a human and/or electronic device. Examples of input/output devices 830 that may be connected to input/output interface include, but are not limited to, keyboard, mouse, trackball, printers, displays, sensor, switch, relay, speaker, microphone, still and/or video camera, etc. In another embodiment, communication interface 810 may comprise, or be comprised by, human input/output interface 812. Communication interface 810 may be configured to communicate directly with a networked component or utilize one or more networks, such as network 820 and/or network 824.

Network 104 may be embodied, in whole or in part, as network 820. Network 820 may be a wired network (e.g., Ethernet), wireless (e.g., WiFi, Bluetooth, cellular, etc.) network, or combination thereof and enable device 802 to communicate with networked component(s) 822. In other embodiments, network 820 may be embodied, in whole or in part, as a telephony network (e.g., public switched telephone network (PSTN), private branch exchange (PBX), cellular telephony network, etc.)

Additionally or alternatively, one or more other networks may be utilized. For example, network 824 may represent a second network, which may facilitate communication with components utilized by device 802. For example, network 824 may be an internal network to a business entity or other organization, such as contact center 102, whereby components are trusted (or at least more so) that networked components 822, which may be connected to network 820 comprising a public network (e.g., Internet) that may not be as trusted.

Components attached to network 824 may include memory 826, data storage 828, input/output device(s) 830, and/or other components that may be accessible to processor 804. For example, memory 826 and/or data storage 828 may supplement or supplant memory 806 and/or data storage 808 entirely or for a particular task or purpose. For example, memory 826 and/or data storage 828 may be an external data repository (e.g., server farm, array, “cloud,” etc.) and enable device 802, and/or other devices, to access data thereon. Similarly, input/output device(s) 830 may be accessed by processor 804 via human input/output interface 812 and/or via communication interface 810 either directly, via network 824, via network 820 alone (not shown), or via networks 824 and 820. Each of memory 806, data storage 808, memory 826, data storage 828 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 830 may be a router, switch, port, or other communication component such that a particular output of processor 804 enables (or disables) input/output device 830, which may be associated with network 820 and/or network 824, to allow (or disallow) communications between two or more nodes on network 820 and/or network 824. For example, a connection between one particular customer, using a particular customer communication device 108, may be enabled (or disabled) with a particular networked component 822 and/or particular resource 112. Similarly, one particular networked component 822 and/or resource 112 may be enabled (or disabled) from communicating with a particular other networked component 822 and/or resource 112, including, in certain embodiments, device 802 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform’s native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
at least one processor having instructions maintained in a non-transitory memory that cause the at least one processor to perform:
selecting a subset of customer attributes selected from a set of known customer attributes, as the most relevant customer attributes for a communication comprising a customer and an agent and wherein the subset of customer attributes is further limited to only customer attributes that are able to be encoded as a cue to cause the cue to have a presentation duration that does not exceed the duration of a ring signal when presented on an agent device to announce the communication;
signaling the agent device to present the cue to announce the communication and omitting the ring signal;
upon determining the cue has been presented by the agent device, establishing the communication comprising connecting the agent device to the customer device via a communication network.

2. The system of claim 1, wherein the selecting of the subset of customer attributes comprises:
providing the set of known customer attributes to a neural network trained to determine the most relevant customer attributes for the communication; and
receiving, from the neural network, the subset of customer attributes.

3. The system of claim 2, wherein the at least one processor further performs a computer-implemented method of training the neural network to determine most relevant customer attributes to incorporate into the communication for success of the communication, from the set of known customer attributes, comprising:
collecting set of most relevant customer attributes from a database;
applying one or more transformations to each most relevant customer attribute including deletion, adding an omitted customer attribute, emphasizing one but less than all most relevant customer attributes, deemphasizing at least one but less than all most relevant customer attributes to create a modified set of most relevant customer attributes;
creating a first training set comprising the collected set of most relevant customer attributes, the modified set of most relevant customer attributes, and a set of not most relevant customer attributes;
training the neural network in a first stage using the first training set;
creating a second training set for a second stage of training comprising the first training set and the set of not most relevant customer attributes that are incorrectly detected as most relevant customer attributes after the first stage of training; and
training the neural network in the second stage using the second training set.

4. The system of claim 2, wherein the at least one processor further performs a computer-implemented method of training the neural network to determine not most relevant customer attributes to exclude from the communication for success of the communication, from the set of known customer attributes, comprising:
collecting set of not most relevant customer attributes from a database;
applying one or more transformations to each not most relevant customer attribute including deletion, adding an omitted customer attribute, emphasizing one but less than all not most relevant customer attributes, deemphasizing at least one but less than all not most relevant customer attributes to create a modified set of not most relevant customer attributes;
creating a first training set comprising the collected set of not most relevant customer attributes, the modified set of not most relevant customer attributes, and a set of most relevant customer attributes;
training the neural network in a first stage using the first training set;
creating a second training set for a second stage of training comprising the first training set and the set of most relevant customer attributes that are incorrectly detected as not most relevant customer attributes after the first stage of training; and
training the neural network in the second stage using the second training set; and
receiving wherein.

5. The system of claim 2, wherein the neural network is trained to determine the most relevant customer attributes for the communication comprising receiving feedback from at least one prior agent on at least one prior communication, wherein the feedback identifies at least one customer attribute as being most relevant prior or at least one customer attribute not being most relevant.

6. The system of claim 1 wherein the duration of the ring signal is two seconds or less.

7. The system of claim 1, further comprising the processor:
accessing a comprehension rate for the agent; and
wherein the cue comprises a volume of information determined to be presented within the presentation duration and presented at a rate not exceeding the comprehension rate for the agent.

8. The system of claim 1, wherein the cue comprises generated speech.

9. The system of claim 1, wherein the cue comprises generated text.

10. The system of claim 1, wherein the cue comprises one or more non-speech tones representing one or more portions of the cue.

11. A system, comprising:
at least one processor having instructions maintained in a non-transitory memory that cause the at least one processor to perform:
accessing a comprehension rate for the agent;
selecting a subset of customer attributes selected from a set of known customer attributes, as the most relevant customer attributes for a communication comprising a customer and an agent and wherein the subset of customer attributes is further limited to only customer attributes that are able to be encoded as a cue to cause the cue to have a presentation duration that does not exceed a volume of information determined to be presented within the presentation duration and presented at a rate not exceeding the comprehension rate for the agent; and
during the communication, signaling an agent device to present the cue.

12. The system of claim 11, wherein the selecting of the subset of customer attributes comprises:
providing the set of known customer attributes to a neural network trained to determine the most relevant customer attributes for the communication; and
receiving, from the neural network, the subset of customer attributes.

13. The system of claim 12, wherein the at least one processor further performs a computer-implemented method of training the neural network to determine most relevant customer attributes to incorporate into the communication for success of the communication, from the set of known customer attributes, comprising:
collecting set of most relevant customer attributes from a database;
applying one or more transformations to each most relevant customer attribute including deletion, adding an omitted customer attribute, emphasizing one but less than all most relevant customer attributes, deemphasizing at least one but less than all most relevant customer attributes to create a modified set of most relevant customer attributes;
creating a first training set comprising the collected set of most relevant customer attributes, the modified set of most relevant customer attributes, and a set of not most relevant customer attributes;
training the neural network in a first stage using the first training set;
creating a second training set for a second stage of training comprising the first training set and the set of not most relevant customer attributes that are incorrectly detected as most relevant customer attributes after the first stage of training; and
training the neural network in the second stage using the second training set.

14. The system of claim 12, wherein the at least one processor further performs a computer-implemented method of training the neural network to determine not most relevant customer attributes to exclude from the communication for success of the communication, from the set of known customer attributes, comprising:
collecting set of not most relevant customer attributes from a database;
applying one or more transformations to each not most relevant customer attribute including deletion, adding an omitted customer attribute, emphasizing one but less than all not most relevant customer attributes, deemphasizing at least one but less than all not most relevant customer attributes to create a modified set of not most relevant customer attributes;
creating a first training set comprising the collected set of not most relevant customer attributes, the modified set of not most relevant customer attributes, and a set of most relevant customer attributes;
training the neural network in a first stage using the first training set;
creating a second training set for a second stage of training comprising the first training set and the set of most relevant customer attributes that are incorrectly detected as not most relevant customer attributes after the first stage of training; and
training the neural network in the second stage using the second training set; and
receiving wherein.

15. The system of claim 12, wherein the cue comprises at least one of generated speech, generated text, or one or more non-speech tones representing one or more portions of the cue.

16. A system, comprising:
at least one processor having instructions maintained in a non-transitory memory that cause the at least one processor to perform:
selecting a subset of agent communication attributes selected from a set of known agent communication attributes, as the most relevant agent communication for a communication comprising a customer and an agent and wherein the subset of agent communication is further limited to only agent communication attributes that are able to be encoded as a cue to cause the cue to have a presentation duration that does not exceed the duration of a ring signal when presented on a customer device to announce the communication;
signaling the customer device to present the cue to announce the communication and omitting the ring signal;
upon determining the cue has been presented by the customer device, establishing the communication comprising connecting the agent device to the customer device via a communication network.

17. The system of claim 16, further comprising the processor:
accessing a comprehension rate for the customer; and
wherein the cue comprises a volume of information determined to be presented within the presentation duration and presented at a rate not exceeding the comprehension rate for the customer.

18. The system of claim 16 wherein the duration of the ring signal is two seconds or less.

19. The system of claim 16, wherein the selecting of the subset of agent attributes comprises:
providing the set of known agent attributes to a neural network trained to determine the most relevant agent attributes for the communication; and
receiving, from the neural network, the subset of agent attributes.

20. The system of claim 19, wherein the at least one processor further performs a computer-implemented method of training the neural network to determine most relevant agent attributes to incorporate into the communication for success of the communication, from the set of known customer attributes, comprising:
collecting set of most relevant agent attributes from a database;
applying one or more transformations to each most relevant agent attribute including deletion, adding an omitted agent attribute, emphasizing one but less than all most relevant agent attributes, deemphasizing at least one but less than all most relevant agent attributes to create a modified set of most relevant agent attributes;
creating a first training set comprising the collected set of most relevant agent attributes, the modified set of most relevant agent attributes, and a set of not most relevant agent attributes;
training the neural network in a first stage using the first training set;
creating a second training set for a second stage of training comprising the first training set and the set of not most relevant agent attributes that are incorrectly detected as most relevant agent attributes after the first stage of training; and
training the neural network in the second stage using the second training set.
